(19) United States
(12) Patent Application Publication
(10) Pub. No.: US 2009/0085947 A1
(43) Pub. Date: Apr. 2, 2009

(54) INKJET RECORDING DEVICE, IMAGE FORMING METHOD AND RECORDING DEVICE

(75) Inventors: Takashi Kado, Izunokuni-shi (JP); Masashi Hiroki, Yokohama-shi (JP); Satoshi Kaiho, Yokohama-shi (JP); Atsushi Kubota, Sunto-gun (JP); Kazuhiko Ohtsu, Mishima-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/206,112

(22) Filed: Sep. 8, 2008

Related U.S. Application Data
(60) Provisional application No. 60/976,144, filed on Sep. 28, 2007.

(51) Int. Cl. B41J 29/38

(52) U.S. Cl. 347/16

(57) ABSTRACT

An inkjet recording device has a conveying path, a feed mechanism configured to feed the paper sheet on the conveying path in the feed direction, an inkjet head configured to make droplets land on the paper sheet, a suction mechanism configured to suction the paper sheet towards the conveying path, and the control mechanism configured to predict the extent of the cockling caused in the paper sheet on which the droplets land based on either one of paper sheet information of the paper sheet and information of the image to be formed on the paper sheet to control suction force of the suction mechanism in accordance with the degree of the cockling.

### CROSS-REFERENCE TO RELATED APPLICATIONS

This application claims the benefit of U.S. Provisional Application No. 60/976,144, filed Sep. 28, 2007.

### TECHNICAL FIELD

The present invention relates to an inkjet recording device having an inkjet head, and an image forming method and a recording device each using an inkjet head.

### BACKGROUND

When forming an image on a paper sheet using inkjet method, a cockling phenomenon, that the paper sheet absorbing a large quantity of ink swells to have a wavy shape, sometimes occurs. JP-A-2006-289955 discloses a recording device capable of preventing the cockling phenomenon. The recording device includes a control section, a suction unit for holding a paper sheet by suction, a sheet conveying means for conveying the paper sheet from the upstream of the suction unit to the downstream thereof, and a user interface for changing the suction force of the suction unit.

In the recording device, the user inputs the type of the paper sheet via a user interface such as a personal computer. A printer driver installed in the personal computer outputs signals to the control section, and the control section controls the suction force of the suction unit. Thus, strong suction force is applied to the standard paper with significant cockling. Further, weak suction force is applied to the inkjet paper with mild cockling.

However, in the recording device described above, it is required to select the type of the paper sheet via the user interface every printing, which makes the operation for instructing printing cumbersome.

### SUMMARY

An object of the invention is to provide an inkjet recording device capable of preventing Qockling of paper sheets while keeping the simple structure.

In order for achieving the object described above, an inkjet recording device according to an aspect of the invention includes a conveying path, a feed mechanism configured to feed a paper sheet on the conveying path in a feed direction, an inkjet head configured to make a droplet land on the paper sheet, a suction mechanism configured to suction the paper sheet towards the conveying path, and a control mechanism configured to predict an extent of cockling caused on the paper sheet on which the droplet lands based on one of paper sheet information of the paper sheet and information of an image to be formed on the paper sheet to control suction force of the suction mechanism in accordance with the extent of cockling.

In order for achieving the object described above, an image forming method according to another aspect of the invention includes predicting an extent of cockling caused in a paper sheet on which a droplet lands based on one of paper sheet information of the paper sheet and image information of an image to be formed on the paper sheet, suctioning the paper sheet towards a conveying path by applying different suction force to the paper sheet by a suction section in accordance with the extent of the cockling, and making the droplets ejected from an inkjet head land on the paper sheet.

In order for achieving the object described above, a recording device according to still another aspect of the invention includes a conveying path, means for feeding a paper sheet on the conveying path in a feed direction, means for making a droplet land on the paper sheet, means for suctioning the paper sheet towards the conveying path, and means for predicting an extent of cockling caused on the paper sheet on which the droplet lands based on one of paper sheet information of the paper sheet and information of an image to be formed on the paper sheet to control suction force of the suction means in accordance with the extent of the cockling.

According to the invention, an inkjet recording device capable of preventing cockling of paper sheets while keeping the simple structure can be provided.

Objects and advantages of the invention will become apparent from the description which follows, or may be learned by practice of the invention.

### DESCRIPTION OF THE DRAWINGS

The accompanying drawings illustrate embodiments of the invention, and together with the general description given above and the detailed description given below, serve to explain the principles of the invention.

FIG. 1 is a schematic diagram showing an inkjet recording device according to a first embodiment.

FIG. 2 is a top view of a paper sheet showing block splitting when calculating the coverage rate of a paper sheet used in the inkjet recording device shown in FIG. 1.

FIG. 3 is a schematic diagram showing an inkjet recording device according to a second embodiment.

FIG. 4 is a schematic diagram showing an inkjet recording device according to third and fourth embodiments.

FIG. 5 is a table chart for comparing paper sheets available to the user in Japan, North America, and Europe.

### DETAILED DESCRIPTION

The inkjet recording device according to the invention will hereinafter be explained with reference to the accompanying drawings.

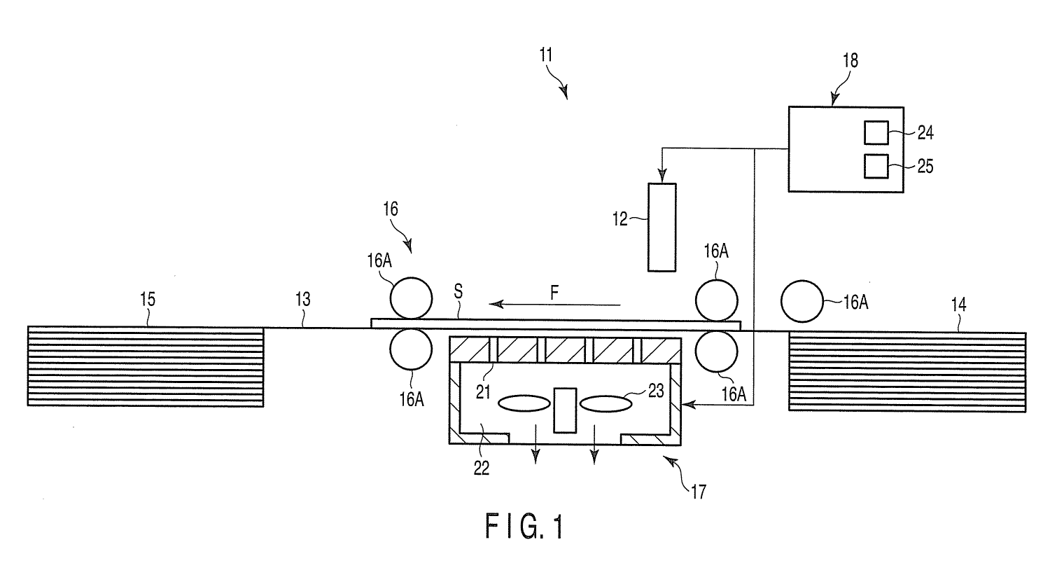

As shown in FIG. 1, the inkjet recording device 11 has an inkjet head 12 for making droplets land on a paper sheet S, a conveying path 13 through which the paper sheet S is conveyed, a paper feed section 14 for supplying the conveying path 13 with the paper sheet S, a paper discharge section 15 for collecting the paper sheet S having an image formed thereon from the conveying path 13, a feed mechanism 16 for feeding the paper sheet on the conveying path 13 in a feed direction F, a suction mechanism 17 for suctioning the paper sheet S towards the conveying path 13, and a control mechanism 18 for integrally controlling the inkjet head 12, the feed mechanism 16, and the suction mechanism 17.

The inkjet head 12 can eject droplets, namely ink droplets, to the paper sheet S. The inkjet head 12 has a plurality of nozzles, not shown, for ejecting ink. The inkjet head 12 has, for example, a piezoelectric element made of lead zirconium titanate (PZT) and functioning as a driver element. When applying a voltage to the piezoelectric element, the piezoelectric element is deformed to increase the pressure inside the pressure chamber corresponding to the nozzle. Thus, the droplet is ejected from the nozzle towards the paper sheet.

The feed mechanism 16 has a plurality of drive rollers 16A for feeding the paper sheet S along the feed direction F. The suction mechanism 17 has a plurality of suction nozzles 21, a negative pressure chamber 22 communicated with the suction nozzles 21, and a fan 23 for providing the negative pressure chamber 22 with negative inside pressure. When the fan 23 rotates, the air is suctioned to the inside of the negative pressure chamber 22 via the suction nozzles 21, and as a result, the paper sheet S has close contact with the conveying path 13.

The control mechanism 18 not only controls driving of each sections of the inkjet recording device 11, but also predicts cockling occurring in the paper sheet S on which the droplets land based on the information of the image to be formed on the paper sheet S. The control mechanism 18 has a coverage rate calculation section 24 for calculating the coverage rate, and a drive section 25 for controlling the suction force of the suction mechanism 17 based on the coverage rate calculated by the coverage rate calculation section 24.

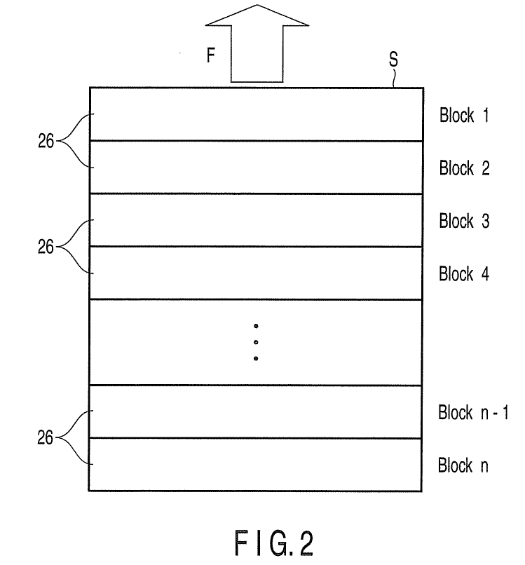

Subsequently, the image forming method using the inkjet recording device 11 will be explained. The coverage rate calculation section 24 calculates the coverage rate from the distribution density of the droplets to be made land on the paper sheet S. The coverage rate represents the proportion of the part of the paper surface on which a dot is actually formed with the droplet with respect to the entire paper surface in percentage. As shown in FIG. 2, the coverage rate is calculated in every block 26 formed by dividing the paper sheet S, for example, along the feed direction F of the paper sheet S. Further, the coverage rate is calculated based on the total dots including every color.

The coverage rate calculation section 24 compares the coverage rates obtained in the bocks 26 with each other to extract the maximum one. The coverage rate calculation section 24 takes the value of 20% as a threshold value, for example, and discriminates whether or not the maximum one of the coverage rates thus calculated exceeds the value of 20% as the threshold value. The coverage rate calculation section 24 sends the discrimination result to the drive section 25. The drive section 25 controls the suction force of the suction mechanism 17 to be the negative pressure of, for example, −100 Pa as first suction force when the coverage rate exceeds the value of 20% as the threshold value. The drive section 25 controls the suction force of the suction mechanism 17 to be the negative pressure of, for example, −7 Pa as second suction force when the coverage rate is lower than the value of 20%.

Thus, the strong suction force is applied to the paper sheet S with a high coverage rate and thus expected to have significant cockling. Therefore, the paper sheet S is suctioned with strong force towards the conveying path 13. On the other hand, the weak suction force is applied to the paper sheet S with a low coverage rate and thus expected to have mild cockling. Therefore, the paper sheet S is suctioned with weak force towards the conveying path 13. According to the control described above, the paper sheet S can be prevented from lifting from the conveying path 13. In this condition, the inkjet head 12 makes the droplets land on the paper sheet S.

Note that although in the present embodiment the threshold value of the coverage rate is set to 20%, and the two levels of suction force are prepared, it is also possible to set two thresholds of the coverage rate and three levels of suction force.

According to the first embodiment, the inkjet recording device 11 has the conveying path 13, the feed mechanism 16 for feeding the paper sheet on the conveying path 13 in the feed direction F, the inkjet head 12 for making droplets land on the paper sheet S, the suction mechanism 17 for suctioning the paper sheet S towards the conveying path 13, and the control mechanism 18 for predicting the extent of the cockling caused in the paper sheet S on which the droplets land based on information of the image to be formed on the paper sheet S to control suction force of the suction mechanism 17 in accordance with the degree of the cockling.

Further, the control mechanism 18 has the coverage rate calculation section 24 for calculating the coverage rate from the distribution density of the droplets landing on the paper sheet S and discriminating whether or not the coverage rate exceeds a predetermined threshold value, and the drive section 25 for setting the suction force of the suction mechanism 17 to the first suction force when it is determined that the coverage rate exceeds the predetermined threshold value, and setting the suction force of the suction mechanism 17 to the second suction force weaker than the first suction force when it is determined that the coverage rate is lower than the threshold value.

According to these configurations, the coverage rate calculation section 24 of the control mechanism 18 predicts the amount of cockling caused in the paper sheet S based on the coverage rate as the information of the image formed on the paper sheet S to control the suction force of the suction mechanism 17. Thus, it becomes possible to make the paper sheet S have close contact with the conveying path 13 by applying the strong suction force to the paper sheet if the paper sheet has large extent of cockling while preventing the suction of the paper sheet S form becoming too strong by applying the weak suction force to the paper sheet S is the paper sheet has small extent of cockling. Thus, it becomes possible to appropriately control the paper gap between the inkjet head 12 and the paper sheet S, thereby forming an image on the paper sheet S with high accuracy.

Such control of the paper gap is particularly effective when a plurality of inkjet heads corresponding respectively to the colors is arranged along the feed direction F. Further, according to the configuration described above, since there is no need for asking the user for the judgment every printing, printing operations can easily and quickly be performed.

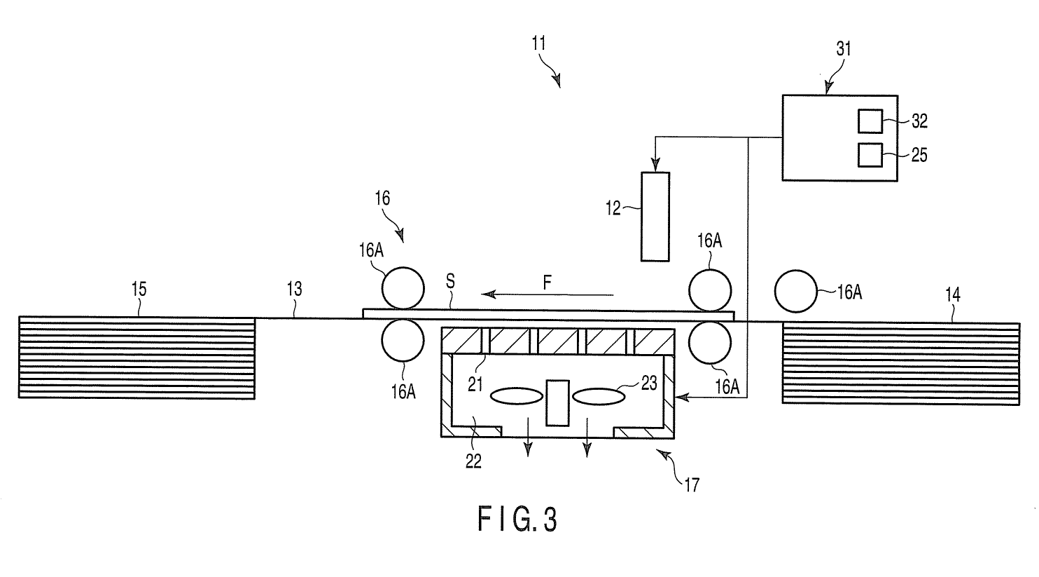

Subsequently, the inkjet recording device according to a second embodiment will be explained with reference to FIG. 3. The inkjet recording device 11 according to the second embodiment is different from that of the first embodiment in the configuration of the control mechanism 31, but has the other sections in common to that of the first embodiment. Therefore, the sections different from the first embodiment will mainly be explained, and the sections common to the first embodiment are denoted with the same reference numerals and the explanations therefor will be omitted.

The control mechanism 31 of the inkjet recording device 11 according to the second embodiment has a discrimination section 32 for discriminating whether what is to be formed on the paper sheet with the droplets is a character or a graphic, and the drive section 25 for controlling the suction force of the suction mechanism 17.

Subsequently, the image forming method used for the inkjet recording device 11 will be explained. Firstly, when sending the print information from the control mechanism 31 to the head driver, not shown, of the inkjet head 12, the discrimination section 32 acquires the print information to discriminate whether what is to be formed on the paper sheet S is a character or a graphic.

The drive section 25 controls the suction force of the suction mechanism 17 to be the negative pressure of, for example, −7 Pa as the second suction force when the discrimination section 32 determines that what is to be formed on the paper sheet S is a character. Further, the drive section 25 controls the suction force of the suction mechanism 17 to be the negative pressure of, for example, −100 Pa as the first suction force when the discrimination section 32 determines that what is to be formed on the paper sheet S is a graphic.

Thus, the suction force of the suction mechanism 17 becomes strong when printing graphics expected to cause significant cockling on the paper sheet S. Therefore, the paper sheet S is suctioned with strong force towards the conveying path 13. On the other hand, when printing characters expected to cause mild cockling on the paper sheet S, the suction force of the suction mechanism 17 becomes weak. Therefore, the paper sheet S is suctioned with weak force towards the conveying path 13. According to the control described above, the paper sheet S can be prevented from lifting from the conveying path 13. In this condition, the inkjet head 12 makes the droplets land on the paper sheet S.

According to the second embodiment, the control mechanism 31 has the discrimination section 32 for discriminating whether what is to be formed on the paper sheet S with the droplets is a character or a graphic, and the drive section 25 for making the suction force of the suction mechanism 17 weak when it is determined that what is to be formed on the paper sheet S is a character while making the suction force of the suction mechanism 17 strong when it is determined that what is to be formed on the paper sheet S is a graphic.

It is common that the recording density increases when forming a graphic such as a photograph on the paper sheet S, and the recording density decreases when forming a letter or a symbol on the paper sheet S. According to this configuration, the level of the recording density can easily be determined by discriminating whether what is to be formed on the paper sheet S is a character or a graphic, thereby appropriately setting the suction force of the suction mechanism 17. Thus, the paper gap between the inkjet head 12 and the paper sheet S can appropriately be controlled.

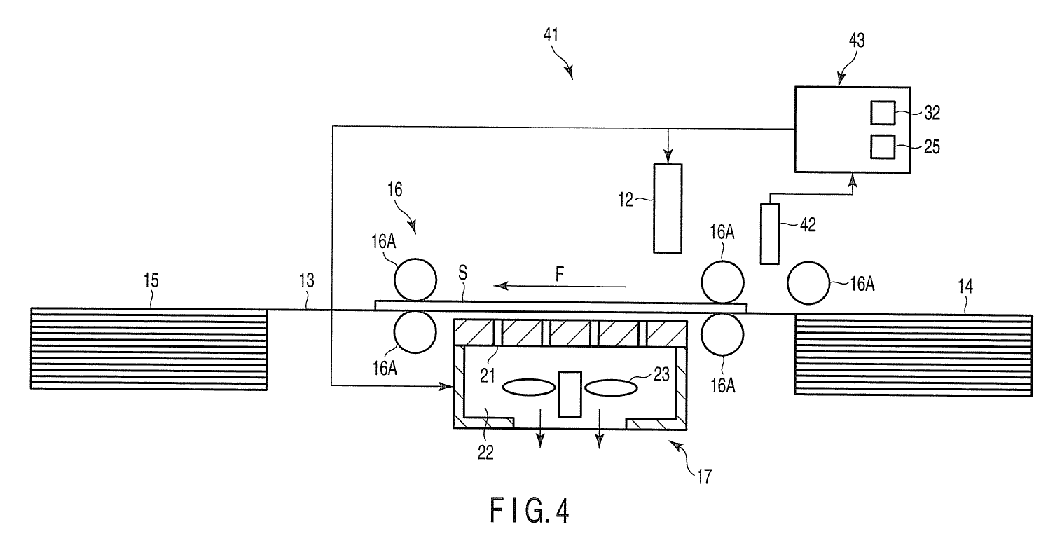

Subsequently, the inkjet recording device according to a third embodiment will be explained with reference to FIG. 4. The inkjet recording device 41 according to the third embodiment is different from that of the first embodiment in having a sensor 42 and in the configuration of the control mechanism 43, but has the other sections in common to that of the first embodiment. Therefore, the sections different from the first embodiment will mainly be explained, and the sections common to the first embodiment are denoted with the same reference numerals and the explanations therefor will be omitted.

The inkjet recording device 41 according to the third embodiment has the inkjet head 12 for ejecting droplets to the paper sheet S, the conveying path 13 through which the paper sheet S is conveyed, the paper feed section 14 for supplying the conveying path 13 with the paper sheet S, the paper discharge section 15 for collecting the paper sheet S having an image formed thereon from the conveying path 13, the feed mechanism 16 for feeding the paper sheet S along the conveying path 13, the suction mechanism 17 for suctioning the paper sheet S towards the conveying path 13, the sensor 42 for detecting the thickness of the paper sheet S fed on the conveying path 13, and the control mechanism 43 for integrally controlling the inkjet head 12, the feed mechanism 16, the suction mechanism 17, and the sensor 42.

The sensor 42 is formed, for example, of a laser displacement gauge. The sensor 42 can directly detect the thickness of the paper sheet S using a laser beam.

The control mechanism 43 has a discrimination section 32 for discriminating whether or not the thickness of the paper sheet S exceeds a predetermined threshold value, and the drive section 25 for controlling the suction force of the suction mechanism 17.

Subsequently, the image forming method used for the inkjet recording device 41 will be explained. The discrimination section 32 firstly discriminates whether or not the thickness of the paper sheet S exceeds 100 μm taking 100 μm, for example, as the threshold value. When the discrimination section 32 determines that the thickness of the paper sheet S detected by the sensor 42 exceeds 100 μm, the drive section 25 controls the suction force of the suction mechanism 17 to be the negative pressure of, for example, −100 Pa as the first suction force. Further, when the discrimination section 32 determines that the thickness of the paper sheet S is smaller than 100 μm, the drive section 25 controls the suction force of the suction mechanism 17 to be the negative pressure of, for example, −7 Pa as the second suction force.

Thus, the strong suction force of the suction mechanism 17 is applied to the thick paper sheet S expected to need strong force for correcting cockling. Thus, the paper sheet S is suctioned with strong force towards the conveying path 13. On the other hand, the weak suction force of the suction mechanism 17 is applied to the thin paper sheet S the cockling of which can sufficiently be corrected with only weak force. Thus, the paper sheet S is suctioned with weak force towards the conveying path 13. According to the control described above, the paper sheet S can be prevented from lifting from the conveying path 13. In this condition, the inkjet head 12 makes the droplets land on the paper sheet S.

Note that although in the present embodiment the threshold value of the thickness of the paper sheet S is set to 100 μm, and the two levels of suction force are prepared, it is also possible to set two thresholds of the thickness of the paper sheet S and three levels of suction force.

According to the third embodiment, the inkjet recording device 41 has the conveying path 13, the feed mechanism 16 for feeding the paper sheet S on the conveying path 13 in the feed direction, the inkjet head 12 for making droplets land on the paper sheet S, the suction mechanism 17 for suctioning the paper sheet S towards the conveying path 13, and the control mechanism 43 for predicting the extent of the cockling caused in the paper sheet S on which the droplets land based on the paper sheet information of the paper sheet S to control suction force of the suction mechanism 17 in accordance with the degree of the cockling.

Further, the control mechanism 43 has the discrimination section 32 for discriminating whether or not the thickness of the paper sheet S exceeds a predetermined threshold value, and the drive section 25 for making the suction force of the suction mechanism 17 strong when it is determined that the thickness of the paper sheet S exceeds the threshold value while making the suction force of the suction mechanism 17 weak when it is determined that the thickness of the paper sheet S is smaller than the threshold value.

According to the configuration, it becomes possible to predict the extent of the cockling caused in the paper sheet S based on the thickness of the paper sheet S as the paper sheet information of the paper sheet S, thereby changing the suction force applied to the paper sheet S. Thus, it is possible to make the thick paper sheet S requiring strong force to correct the cockling have close contact with the conveying path 13 by increasing the suction force applied to the paper sheet S. Further, regarding the thin paper sheet S not requiring strong force for correcting the cockling, it is possible to prevent the suction force applied to the paper sheet S from becoming too strong by applying weak suction force to the paper sheet S. Thus, it becomes possible to appropriately control the paper gap between the inkjet head 12 and the paper sheet S, thereby forming an image on the paper sheet S with high accuracy.

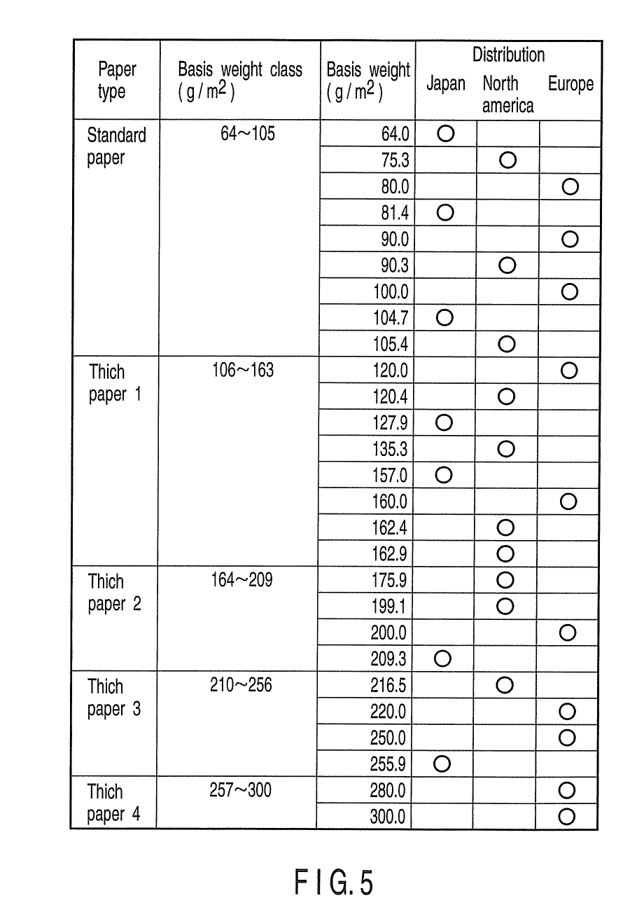

Subsequently, the inkjet recording device according to a fourth embodiment will be explained with reference to FIGS. 4 and 5. The inkjet recording device 41 according to the fourth embodiment is different from that of the third embodiment in discriminating the paper sheet S based on the weight of the paper sheet S, but has the other sections in common to that of the third embodiment. Therefore, the sections different from the third embodiment will mainly be explained, and the sections common to the third embodiment are denoted with the same reference numerals and the explanations therefor will be omitted.

The inkjet recording device 41 according to the fourth embodiment has the inkjet head 12 for ejecting droplets to the paper sheet S, the conveying path 13 through which the paper sheet S is conveyed, the paper feed section 14 for supplying the conveying path 13 with the paper sheet S, the paper discharge section 15 for collecting the paper sheet S having an image formed thereon from the conveying path 13, the feed mechanism 16 for feeding the paper sheet S along the conveying path 13, the suction mechanism 17 for suctioning the paper sheet S towards the conveying path 13, the sensor 42 for detecting the thickness of the paper sheet S fed on the conveying path 13, and the control mechanism 43 for integrally controlling the inkjet head 12, the feed mechanism 16, the suction mechanism 17, and the sensor 42.

The sensor 42 is formed, for example, of a laser displacement gauge. The sensor 42 can directly detect the thickness of the paper sheet S using a laser beam.

The control mechanism 43 has a discrimination section 32 for discriminating whether or not the basis weight of the paper sheet S exceeds a predetermined threshold value, and the drive section 25 for controlling the suction force of the suction mechanism 17. The basis weight denotes the weight of the paper sheet S per unit area.

Subsequently, the image forming method used for the inkjet recording device 41 will be explained. The discrimination section 32 firstly calculates the basis weight (g/m²) of the paper sheet S by multiplying the thickness value of the paper sheet S detected by the sensor 42 by the value of the density of the paper sheet S measured previously. Further, the discrimination section 32 discriminates whether or not the basis weight of the paper sheet S exceeds 120 g/m² taking 120 g/m², for example, as the threshold value. When it is determined that the basis weight of the paper sheet S exceeds 120 g/m², the drive section 25 controls the suction force of the suction mechanism 17 to be the negative pressure of, for example, −100 Pa as the first suction force.

Further, when it is determined that the basis weight of the paper sheet S is lower than 120 g/m², the drive section 25 controls the suction force of the suction mechanism 17 to be the negative pressure of, for example, −7 Pa as the second suction force.

Thus, the strong suction force of the suction mechanism 17 is applied to the paper sheet (thick paper), which is heavy, high in rigidity, and expected to need strong force for correcting cockling. Thus, the paper sheet S is suctioned with strong force towards the conveying path 13. On the other hand, the weak suction force of the suction mechanism 17 is applied to the paper sheet (standard paper), which is light, low in rigidity, and requires only weak force for sufficiently correcting cockling. Thus, the paper sheet S is suctioned with weak force towards the conveying path 13. According to the control described above, the paper sheet S can be prevented from lifting from the conveying path 13. In this condition, the inkjet head 12 makes the droplets land on the paper sheet S.

Note that although in the present embodiment the threshold value of the basis weight of the paper sheet S is set to 120 g/m², and the two levels of suction force are prepared, it is also possible to set two thresholds of the basis weight of the paper sheet S and three levels of suction force.

According to the fourth embodiment, the control mechanism 43 has the discrimination section 32 for discriminating whether or not the weight of the paper sheet S exceeds a predetermined threshold value, and the drive section 25 for making the suction force of the suction mechanism 17 strong when it is determined that the weight of the paper sheet S exceeds the threshold value while making the suction force of the suction mechanism 17 weak when it is determined that the weight of the paper sheet S is smaller than the threshold value.

According to the configuration, it becomes possible to predict the extent of the cockling caused in the paper sheet S based on the weight of the paper sheet S as the paper sheet information of the paper sheet S, thereby changing the suction force applied to the paper sheet S. Thus, it is possible to make the thick paper sheet S requiring strong force to correct the cockling have close contact with the conveying path 13 by increasing the suction force applied to the paper sheet S. Further, regarding the thin paper sheet S not requiring strong force for correcting the cockling, it is possible to prevent the suction force applied to the paper sheet S from becoming too strong by applying weak suction force to the paper sheet S. Thus, it becomes possible to appropriately control the paper gap between the inkjet head 12 and the paper sheet S, thereby forming an image on the paper sheet S with high accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An inkjet recording device comprising:
a conveying path;
a feed mechanism configured to feed a paper sheet on the conveying path in a feed direction;
an inkjet head for making a droplet land on the paper sheet;
a suction mechanism configured to suction the paper sheet towards the conveying path; and
a control mechanism configured to predict an extent of cockling caused on the paper sheet on which the droplet lands based on one of paper sheet information of the paper sheet and information of an image to be formed on the paper sheet to control suction force of the suction mechanism in accordance with the extent of cockling.

2. The device according to claim 1,
wherein the control mechanism includes
a coverage rate calculation section configured to calculate a coverage rate from a distribution density of the droplets landing on the paper sheet to discriminate whether or not the coverage rate exceeds a predetermined threshold value, and
a drive section configured to make the suction force of the suction mechanism become first suction force in response to determination that the coverage rate exceeds the predetermined threshold value, and making the suction force of the suction mechanism become second suction force weaker than the first suction force in response to determination that the coverage rate is lower than the predetermined threshold value.

3. The device according to claim 1,
wherein the control mechanism includes
a discrimination section configured to discriminate whether what is to be formed on the paper sheet with the droplets is a character or a graphic, and
a drive section configured to make the suction force of the suction mechanism become first suction force in response to determination that what is to be formed on the paper sheet is a graphic, and making the suction force of the suction mechanism become second suction force weaker than the first suction force in response to determination that what is to be formed on the paper sheet is a character.

4. The device according to claim 1,
wherein the control mechanism includes
a discrimination section configured to discriminate whether or not a thickness of the paper sheet exceeds a predetermined threshold value, and
a drive section configured to make the suction force of the suction mechanism become first suction force in response to determination that the thickness of the paper sheet exceeds the threshold value, and making the suction force of the suction mechanism become second suction force weaker than the first suction force in response to determination that the thickness of the paper sheet is smaller than the threshold value.

5. The device according to claim 1,
wherein the control mechanism includes
a discrimination section configured to discriminate whether or not a weight of the paper sheet exceeds a predetermined threshold value, and
a drive section configured to make the suction force of the suction mechanism become first suction force in response to determination that the weight of the paper sheet exceeds the threshold value, and making the suction force of the suction mechanism become second suction force weaker than the first suction force in response to determination that the weight of the paper sheet is lower than the threshold value.

6. An image forming method comprising:
predicting an extent of cockling caused in a paper sheet on which a droplet lands based on one of paper sheet information of the paper sheet and information of an image to be formed on the paper sheet;
suctioning the paper sheet towards a conveying path by applying different suction force to the paper sheet in accordance with the extent of the cockling; and
making the droplet ejected from an inkjet head land on the paper sheet.

7. The method according to claim 6, further comprising:
calculating a coverage rate from a distribution density of the droplets landing on the paper sheet;
discriminating by the coverage rate calculation section whether of not the coverage rate exceeds a predetermined threshold value;
making the suction force of the suction section become first suction force in response to the coverage rate exceeding the predetermined threshold value after the discriminating step; and
making the suction force of the suction section become second suction force weaker than the first suction force in response to the coverage rate being lower than the predetermined threshold value after the discriminating step.

8. The method according to claim 6, further comprising:
discriminating whether what is to be formed on the paper sheet with the droplets is a character or a graphic;
making the suction force of the suction section by a drive section become first suction force in response to determination that what is to be formed on the paper sheet is a graphic; and
making the suction force of the suction section by the drive section become second suction force weaker than the first suction force in response to the determination that what is to be formed on the paper sheet is a character.

9. The method according to claim 6, further comprising:
discriminating whether or not a thickness of the paper sheet exceeds a predetermined threshold value;
making the suction force of the suction by a drive section become first suction force in response to determination that the thickness of the paper sheet exceeds the predetermined threshold value; and
making the suction force of the suction section by the drive section become second suction force weaker than the first suction force in response to determination that the thickness of the paper sheet is smaller than the predetermined threshold value.

10. The method according to claim 6, further comprising:
discriminating whether or not a weight of the paper sheet exceeds a predetermined threshold value;
making the suction force of the suction section by a drive section become first suction force in response to determination that the weight of the paper sheet exceeds the predetermined threshold value; and
making the suction force of the suction section by the drive section become second suction force weaker than the first suction force in response to determination that the weight of the paper sheet is lower than the predetermined threshold value.

11. A recording device comprising:
a conveying path;
means for feeding a paper sheet on the conveying path in a feed direction;
means for making a droplet land on the paper sheet;
means for suctioning the paper sheet towards the conveying path; and
means for predicting an extent of cockling caused on the paper sheet on which the droplet lands based on one of paper sheet information of the paper sheet and information of an image to be formed on the paper sheet to control suction force of the suction means in accordance with the extent of the cockling.

12. The device according to claim 11,
wherein the predicting means includes
a coverage rate calculation section configured to calculate a coverage rate from a distribution density of the droplets landing on the paper sheet to discriminate whether or not the coverage rate exceeds a predetermined threshold value, and
a drive section configured to make the suction force of the suction means become first suction force in response to determination that the coverage rate exceeds the predetermined threshold value, and making the suction force of the suction means become second suction force weaker than the first suction force in response to determination that the coverage rate is lower than the predetermined threshold value.

13. The device according to claim 11,
wherein the predicting means includes
a discrimination section configured to discriminate whether what is to be formed on the paper sheet with the droplets is a character or a graphic, and
a drive section configured to make the suction force of the suction means become first suction force in response to determination that what is to be formed on the paper sheet is a graphic, and making the suction force of the suction means become second suction force weaker than the first suction force in response to determination that what is to be formed on the paper sheet is a character.

14. The device according to claim 11,
wherein the predicting means includes
a discrimination section configured to discriminate whether or not a thickness of the paper sheet exceeds a predetermined threshold value, and
a drive section configured to make the suction force of the suction means become first suction force in response to determination that the thickness of the paper sheet exceeds the threshold value, and making the suction force of the suction means become second suction force weaker than the first suction force in response to determination that the thickness of the paper sheet is smaller than the threshold value.

15. The device according to claim 11,
wherein the predicting means includes
a discrimination section configured to discriminate whether or not a weight of the paper sheet exceeds a predetermined threshold value, and
a drive section configured to make the suction force of the suction means become first suction force in response to determination that the weight of the paper sheet exceeds the threshold value, and making the suction force of the suction means become second suction force weaker than the first suction force in response to determination that the weight of the paper sheet is lower than the threshold value.
